(19) United States
(12) Patent Application Publication
(10) Pub. No.: US 2025/0226663 A1
(43) Pub. Date: Jul. 10, 2025

(54) METHOD AND SYSTEM FOR RESPONDING TO AN ENERGY EXPENDITURE EVENT

(71) Applicant: GM GLOBAL TECHNOLOGY OPERATIONS LLC, DETROIT, MI (US)

(72) Inventor: Justin Anthony Bunnell, FARMINGTON HILLS, MI (US)

(21) Appl. No.: 18/408,808

(22) Filed: Jan. 10, 2024

(51) Int. Cl. H02J 3/32; B60L 3/00; B60L 53/62; H02J 3/00; H02J 3/38; H02J 7/00; H02J 7/34

(52) U.S. Cl. CPC H02J 3/322; B60L 3/0046; B60L 53/62; H02J 3/001; H02J 3/38; H02J 7/0048; H02J 7/00712; H02J 7/342; B60L 2240/54

(57) ABSTRACT

A method for handling an energy expenditure event is provided. Aspects include detecting a fault in a first energy storage device and transmitting energy from the first energy storage device to a second energy storage device that is electrically connected to the first energy storage device based on a determination that a state-of-charge of the first energy storage device is above a first threshold value. Aspects also include terminating transmission of energy from the first energy storage device to the second energy storage device based on a determination that the state-of-charge of the first energy storage device has fallen below a second threshold value, which is equal to or lower than the first threshold value.

### INTRODUCTION

The subject disclosure relates to energy storage and charging systems for electric vehicles, and particularly a system for identifying and responding to an energy expenditure event.

Electric and hybrid electric vehicles include energy storage systems, such as battery packs and the like, that store electric energy while the vehicle is non-operational and utilize the stored electric energy while the vehicle is operating. In typical examples, a controller charges the battery to full (100% State of Charge), or as near to full as possible, in preparation for the next vehicle operation. Existing systems typically maximize charging to full as quickly as possible in order to minimize charge time.

The existing systems allow for a vehicle operator to begin operating the vehicle with maximum range potential in as short a time period as possible. However, the existing systems do not allow for the charging profile of the energy storage system to be altered to accommodate for external events that may benefit from a safe energy expenditure pathway. As such, it is desirable to create an energy storage and charging system that allows the charging profile of the electric storage system to be responsive to one or more energy expenditure events.

### SUMMARY

In one exemplary embodiment a method for handling an energy expenditure event is provided. The method includes detecting a fault in a first energy storage device and based on a determination that a state-of-charge of the first energy storage device is above a first threshold value, transmitting energy from the first energy storage device to a second energy storage device that is electrically connected to the first energy storage device. Based on a determination that the state-of-charge of the first energy storage device has fallen below a second threshold value, which is equal to or lower than the first threshold value, the method also includes terminating transmission of energy from the first energy storage device to the second energy storage device.

In addition to one or more of the features described herein, the first energy storage device is disposed on a first vehicle.

In addition to one or more of the features described herein, the second energy storage device is disposed on a stationary device.

In addition to one or more of the features described herein, the second energy storage device is disposed on a second vehicle electrically connected to the first vehicle.

In addition to one or more of the features described herein, the method also includes powering on one or more energy dissipation devices electrically connected to the first energy storage device based on a determination that a state-of-charge of the first energy storage device is above a first threshold value.

In addition to one or more of the features described herein, the method also includes transmitting energy from the first energy storage device to an electric grid that is electrically connected to the first energy storage device based on a determination that the state-of-charge of the first energy storage device is above the first threshold value and that the first energy storage device is not electrically connected to the second energy storage device.

In one exemplary embodiment a method for handling an energy expenditure event is provided. The method includes receiving, from an operator of an electric grid, an indication of a negative electric rate for power delivered from the electric grid and determining a state-of-charge of a first energy storage device. Based on a determination that the state-of-charge of a first energy storage device is less than a maximum state-of-charge, the method includes obtaining power from the electric grid and charging the first energy storage device. Based on a determination that the state-of-charge of the first energy storage device is equal to the maximum state-of-charge, the method includes obtaining power from the electric grid and powering on one or more energy dissipation devices electrically connected to the first energy storage device.

In addition to one or more of the features described herein, the first energy storage device is disposed on a vehicle.

In addition to one or more of the features described herein, the first energy storage device is disposed on a stationary device.

In addition to one or more of the features described herein, the method also includes identifying a second energy storage device that is electrically connected to the first energy storage device, determining a state-of-charge of the second energy storage device, and based on a determination that the state-of-charge of the second energy storage device is less than a maximum state-of-charge of the second energy storage device, obtaining power from the electric grid and charging the second energy storage device.

In addition to one or more of the features described herein, the second energy storage device is disposed on a vehicle.

In addition to one or more of the features described herein, the method also includes obtaining power from the electric grid and powering on one or more energy dissipation devices electrically connected to the second energy storage device based on a determination that the state-of-charge of the second energy storage device is equal to the maximum state-of-charge of the second energy storage device.

In addition to one or more of the features described herein, the indication of the negative electric rate for power delivered from the electric grid is generated based upon a surplus of power received by the electric grid from one or more renewable energy sources.

In addition to one or more of the features described herein, the indication of the negative electric rate for power delivered from the electric grid includes an indication of the negative electric rate and a duration of the negative electric rate.

In one exemplary embodiment a system for handling an energy expenditure event is provided. The system includes an electric grid configured to receive power from one or more renewable energy sources and a stationary device electrically connected to the electric grid, the stationary device including a bi-directional charger, a first energy storage device, and a processing system configured to control an operation of the bi-directional charger. The processing system is configured to receive, from an operator of the electric grid, an indication of a negative electric rate for power delivered from the electric grid and determine a state-of-charge of the first energy storage device. Based on a determination that the state-of-charge of the first energy storage device is less than a maximum state-of-charge, the processing system is configured to obtain power from the electric grid and charging the first energy storage device. Based on a determination that the state-of-charge of the first energy storage device is equal to the maximum state-of-charge, the processing system is configured to obtain power from the electric grid and powering on one or more energy dissipation devices electrically connected to the first energy storage device.

In addition to one or more of the features described herein, the system also includes a vehicle electrically connected to the stationary device, the vehicle comprising a second energy storage device and a processing system that is in communication with the processing system of the stationary device.

In addition to one or more of the features described herein, the processing system is further configured to obtain power from the electric grid and power on one or more energy dissipation devices electrically connected to the first energy storage device based on a determination that the state-of-charge of the first energy storage device is equal to the maximum state-of-charge.

In addition to one or more of the features described herein, processing system is further configured to identify a second energy storage device that is electrically connected to the first energy storage device, determine a state-of-charge of the second energy storage device, and based on a determination that the state-of-charge of the second energy storage device is less than a maximum state-of-charge of the second energy storage device, obtain power from the electric grid and charge the second energy storage device.

In addition to one or more of the features described herein, the second energy storage device is disposed on a vehicle.

In addition to one or more of the features described herein, the processing system of the vehicle is configured to obtain power from the electric grid and power on one or more energy dissipation devices electrically connected to the second energy storage device based on a determination that the state-of-charge of the second energy storage device is equal to the maximum state-of-charge.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a system for responding to an energy expenditure event in accordance with an embodiment;

FIG. 2 is a block diagram of another system for responding to an energy expenditure event in accordance with an embodiment;

FIG. 3 is a schematic diagram of a system for responding to an energy expenditure event in accordance with an embodiment;

FIG. 4 is a flowchart diagram of a method for responding to an energy expenditure event in accordance with an embodiment; and

FIG. 5 is a flowchart diagram of another method for responding to an energy expenditure event in accordance with an embodiment.

### DETAILED DESCRIPTION

The following description is merely exemplary in nature and is not intended to limit the present disclosure, its application, or uses. Various embodiments of the disclosure are described herein with reference to the related drawings. Alternative embodiments of the disclosure can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship.

The charging and discharging of an electric storage system, such as a battery pack disposed in a wall-mounted charging station or a vehicle, is typically controlled by a charging profile. For example, an operator of an electric storage system may configure a charging profile to charge the electric storage system when the state-of-charge falls below twenty percent and to stop charging the electric storage system when the state-of-charge reaches eighty percent. In addition, the charging profile may limit the time of day or days of the week that charging can occur. For example, the charging profile may specify that charging should only occur between the hours of midnight and seven in the morning. In another example, the charging profile may specify that charging may be permitted during different time periods based on the state-of-charge.

In exemplary embodiments, methods, and systems are provided that are configured to deviate from a normal charging profile when an energy expenditure event is experienced. By way of example, an energy expenditure event can occur when an electric storage system, such as a battery pack disposed in a wall-mounted charging station or a vehicle, experiences a fault and/or overcharge. In another example, an energy expenditure event may occur when the cost of consuming power from an electric grid is a negative value, a power surge occurs, or any similar event occurs.

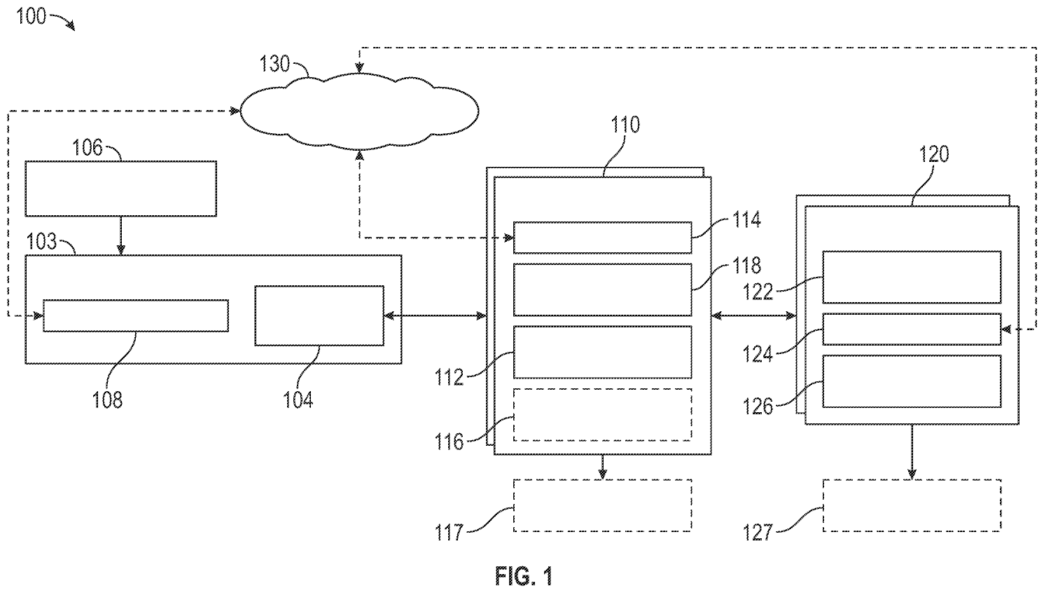

Referring now to FIG. 1, a system 100 for responding to an energy expenditure event in accordance with an embodiment is shown. The system includes an electric grid 103 that is configured to receive power from one or more renewable energy sources 106, such as wind turbines, solar power generation devices, and the like. The electric grid 103 includes a transmission network 104 that is electrically coupled to one or more stationary devices 110. In one embodiment, the stationary devices 110 are electrical vehicle charging stations that include an energy storage device 112. In exemplary embodiments, the electric grid 103 is operated by a processing system 108, which is connected to a communications network 130. The communications network 130 may include one or more of private and public communications networks, such as cellular telephone networks, private networks, and the Internet.

In exemplary embodiments, each of the stationary devices 110 includes an energy storage device 112, a processing system 114, one or more energy dissipation devices 116, and a bi-directional charger 118. In exemplary embodiments, the processing system 114 is configured to control the operation of the stationary device 110. For example, the processing system 114 controls the operation of the bi-directional charger 118 to selectively charge or discharge the energy storage device 112. In exemplary embodiments, the processing system 114 is configured to operate the bi-directional charger 118 to selectively charge or discharge the energy storage device 112 in accordance with a charging profile that specifies the conditions that determine when to charge or discharge the energy storage device 112. For example, the processing system 114 may be configured to charge the energy storage device 112 once a state-of-charge of the energy storage device 112 falls below a minimum threshold percentage and to continue charging the energy storage device 112 unit the state-of-charge reaches a threshold percentage of a maximum state-of-charge of the energy storage device 112.

In exemplary embodiments, the energy dissipation devices 116 are devices that are part of the stationary device 110 that can be selectively activated by the processing system 114 to consume energy from the energy storage device 112 or from the electric grid 103 via the bi-directional charger 118. For example, the energy dissipation devices 116 may include restive heating devices, refrigerant compressors, fans, lights, or the like. In some embodiments, one or more external energy dissipation devices 117 may be coupled to stationary device 110. The external energy dissipation devices 117 are devices that are electrically coupled to the stationary device 110 that can be selectively activated by the processing system 114 to consume energy from the energy storage device 112 or from the electric grid 103 via the bi-directional charger 118.

In exemplary embodiments, the system 100 also includes one or more vehicles 120 that are electrically connected to one of the stationary devices 110. The vehicles 120 each include an energy storage device 122, a processing system 124, and one or more energy dissipation devices 126. In exemplary embodiments, the processing system 124 is configured to control the operation of the vehicle 120. For example, the processing system 124 selectively charges or discharges the energy storage device 122. In exemplary embodiments, the processing system 124 is configured to selectively charge or discharge the energy storage device 122 in accordance with a charging profile that specifies the conditions that determine when to charge or discharge the energy storage device 122. For example, the processing system 124 may be configured to charge the energy storage device 122 when the vehicle 120 is connected to the stationary device 110 until a state-of-charge of the energy storage device 122 reaches a threshold percentage of a maximum state-of-charge of the energy storage device 122.

In exemplary embodiments, the energy dissipation devices 126 are devices that are part of the vehicle 120 that can be selectively activated by the processing system 124 to consume energy from the energy storage device 122. For example, the energy dissipation devices 126 may include restive heating devices, fans, lights, air conditioning devices, spinning a non-firing engine, or the like. In some embodiments, one or more external energy dissipation devices 127 may be coupled to vehicle 120. The external energy dissipation devices 127 are devices that are electrically coupled to the vehicle 120 that can be selectively activated by the processing system 124 to consume energy from the energy storage device 122.

In exemplary embodiments, one or more of the processing system 108 of the electric grid 103, the processing system 114 of the stationary devices 110, and the processing system 124 of the vehicles 120 are configured to communicate with one another via the communications network 130. In exemplary embodiments, the processing system 108 is configured to set a rate charged for power sold by the electric grid 103 and to communicate the rate to the stationary devices 110 and the vehicles 120. In cases where the energy production of renewable energy sources 106 causes a power supply/demand imbalance in the electric grid 103, the processing system 108 is configured to set the rate charged for power sold by the electric grid 103 to be a negative rate, (e.g., a rate that is less than zero dollars per kilowatt hour). In addition, the processing system 108 is configured to transmit a notification of the negative electric rate for power delivered from the electric grid to one or more of the processing system 114 of the stationary devices 110 and the processing system 124 of the vehicles 120 via the communications network. In one embodiment, the indication of the negative electric rate for power delivered from the electric grid includes an indication of the negative electric rate and a duration of the negative electric rate.

In exemplary embodiments, the processing systems 114 of the stationary device 110 is configured to monitor the energy storage device 112 and to detect a fault in the energy storage device 112. Once a fault in the energy storage device 112 is detected, the processing system 114 is configured to take one or more actions to reduce the state-of-charge of the energy storage device 112 below a threshold level. In one embodiment, the processing system 114 is configured to transmit power from the faulty energy storage device 112 to the energy storage device 122 of a vehicle that is electrically connected to the faulty energy storage device 112, 122. In another embodiment, the processing system 114 is configured to transmit power from the faulty energy storage device 112 to the electric grid 103. In another embodiment, the processing system 114 is configured to activate one or more energy dissipation devices 116, 117 that are electrically connected to the energy storage device 112.

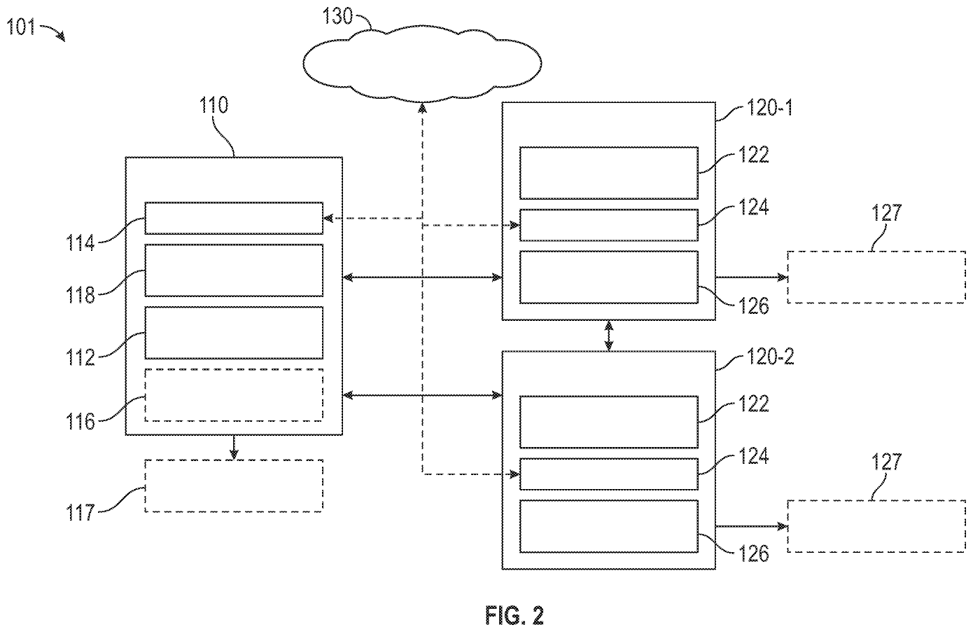

Referring now to FIG. 2, a block diagram of a system 101 for responding to an energy expenditure event in accordance with an embodiment is shown. The system 101 includes a plurality of vehicles 120 that may be selectively electrically connected to a stationary device 110 and/or to another vehicle 120. In exemplary embodiments, the processing systems 114, 124 are configured to monitor the energy storage devices 112, 122 and to detect a fault in the energy storage devices 112, 122. Once a fault in an energy storage device 112, 122 is detected, the corresponding processing system 114, 124 is configured to take actions to reduce the state-of-charge of the faulty energy storage device 112, 122 below a threshold level. In one embodiment, the processing system 114, 124 is configured to transmit power from the faulty energy storage device 112, 122 to another energy storage device that is electrically connected to the faulty energy storage device 112, 122. In another embodiment, the processing system 114, 124 is configured to activate one or more energy dissipation devices 116, 117, 126, 127 that are electrically connected to the faulty energy storage device 112, 122.

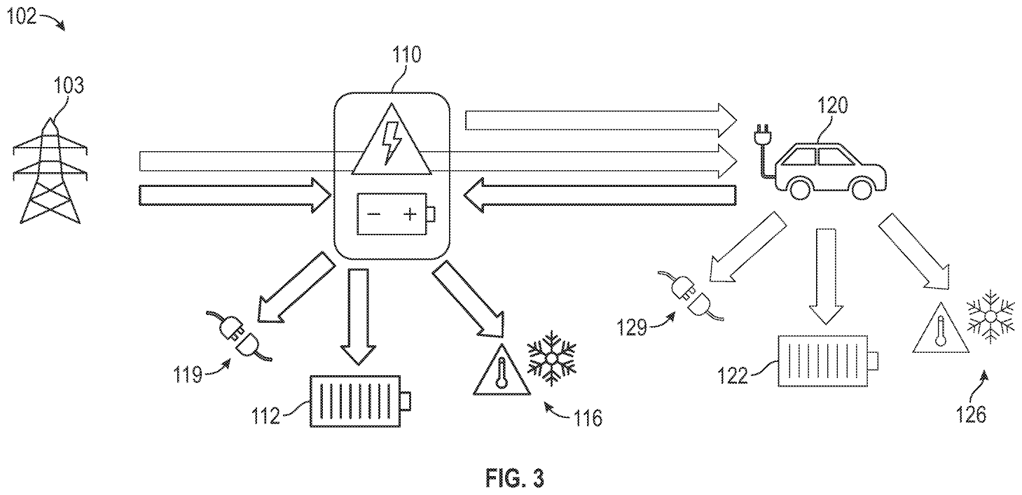

Referring now to FIG. 3, a schematic diagram of a system 102 for responding to an energy expenditure event in accordance with an embodiment is shown. The system 102 includes an electric grid 103 that is electrically connected to a stationary device 110, such as an electric vehicle charging station or a battery backup system. The stationary device 110 is electrically connected to a vehicle 120, such as an electric vehicle or a plug-in hybrid vehicle. In exemplary embodiments, the stationary device 110 includes an energy storage device 112, such as a battery, and one or more energy dissipation devices 116, such as a heater or air conditioning device. The stationary device 110 also includes one or more outlets 119 that can be used to selectively connect external energy dissipation devices to the stationary device 110. Likewise, the vehicle 120 includes an energy storage device 122, such as a battery, and one or more energy dissipation devices 126, such as a heater or air conditioning device. The vehicle 120 also includes one or more outlets 129 that can be used to selectively connect external energy dissipation devices to the vehicle 120.

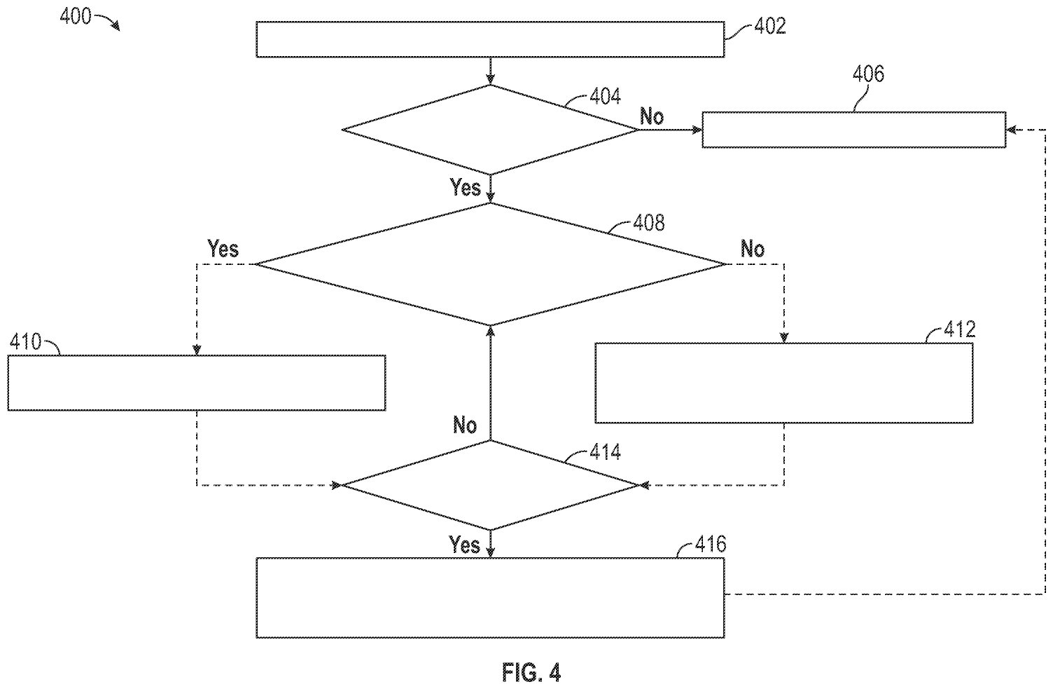

Referring now to FIG. 4, a flowchart diagram of a method 400 for responding to an energy expenditure event in accordance with an embodiment is shown. At block 402, the method 400 includes detecting a fault in a first energy storage device. In one embodiment, the fault may be detected based on a change in temperature or charge of one or more battery cells in the first energy storage device. Next, as shown at decision block 404, a determination is made of whether the state-of-charge of the first energy storage device (SOC₁) is above a first threshold value. In exemplary embodiments, the first threshold value is a maximum state of charge that the energy storage device can be safely operated while experiencing a fault. For example, the first threshold value may be approximately twenty percent. Based on a determination that SOC₁ is not above the first threshold value, the method 400 proceeds to block 406 and sets a maximum state of charge of the first energy storage device (SOCₘₐₓ) to equal the maximum state of charge of the first energy storage device during a fault (SOC_{max_def}), which may be the first threshold value.

Based on a determination that SOC₁ is above the first threshold value, the method 400 proceeds to decision block 408, and a determination is made whether the first energy storage device is electrically connected to a second energy storage device. Based on a determination that the first energy storage device is electrically connected to a second energy storage device, the method 400 proceeds to block 410 and energy is transmitted from the first energy storage device to a second energy storage device that is electrically connected to the first energy storage device. Based on a determination that the first energy storage device is not electrically connected to a second energy storage device, the method 400 proceeds to block 412, and one or more energy dissipation devices electrically connected to the first energy storage device are powered on.

At decision block 414 a determination is made whether the state-of-charge of the first energy storage device (SOC₁) is less than a second threshold value, which may be equal to or lower than the first threshold value. Based on a determination that SOC₁ is less than a second threshold value, the method 400 proceeds to block 416, and the transmission of energy from the first energy storage device to the second energy storage device is stopped and the one or more energy dissipation devices are powered off. Based on a determination that SOC₁ is not less than a second threshold value, the method 400 returns to decision block 408.

In one embodiment, the first energy storage device is disposed on a first vehicle and the second energy storage device is disposed on a stationary device that is electrically connected to the vehicle. In another embodiment, the first energy storage device is disposed on a first vehicle and the second energy storage device is disposed on a second vehicle electrically connected to the first vehicle. In a further embodiment, the second energy storage device is disposed on a vehicle and the first energy storage device is disposed on a stationary device that is electrically connected to the vehicle. In exemplary embodiments, the one or more energy dissipation devices are electrically connected to the first energy storage device.

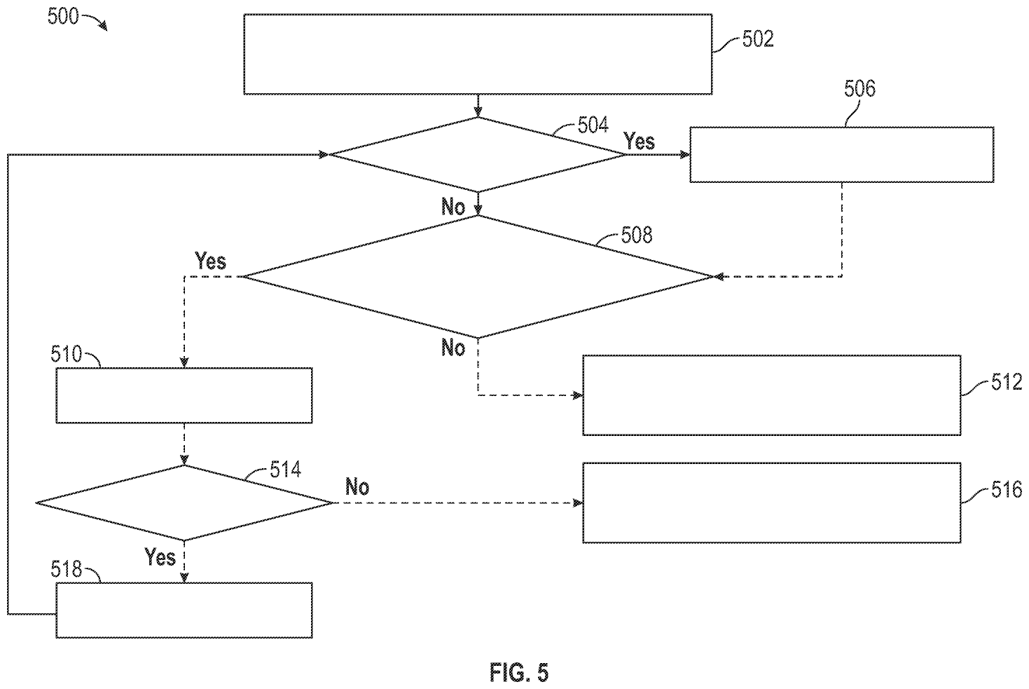

Referring now to FIG. 5, a flowchart diagram of a method 500 for responding to an energy expenditure event in accordance with an embodiment is shown. At block 502, the method 500 includes receiving, by a device having a first energy storage device, an indication of a negative electric rate for power delivered from an electric grid. In exemplary embodiments, the indication of the negative electric rate for power delivered from the electric grid is generated based upon a surplus of power received by the electric grid from one or more renewable energy sources. In one embodiment, the indication of the negative electric rate for power delivered from the electric grid includes an indication of the negative electric rate and a duration of the negative electric rate.

Next, as shown at decision block 504, the method 500 includes determining a state-of-charge of a first energy storage device (SOC₁) is less than a maximum state-of-charge of a first energy storage device (SOC_{MAX_1}). Based on a determination that SOC₁ is less than SOC_{MAX_1}, the method 500 proceeds to block 506 and charges the first energy storage device until SOC₁ is equal to SOC_{MAX_1}. Based on a determination that SOC₁ is not less than SOC_{MAX_1}, the method 500 proceeds to decision block 508, and a determination is made whether the first energy storage device is electrically connected to a second energy storage device. Based on a determination that the first energy storage device is not electrically connected to a second energy storage device, the method 500 proceeds to block 510 and includes obtaining power from the electric grid and powering on one or more energy dissipation devices electrically connected to the first energy storage device.

Based on a determination that the first energy storage device is electrically connected to a second energy storage device, the method 500 proceeds to block 510 and transmits energy from the first energy storage device to the second energy storage device. Next, at decision block 514, the method 500 includes determining whether a state-of-charge of a second energy storage device (SOC₂) is less than the maximum state-of-charge of a second energy storage device (SOC_{MAX_2}). Based on a determination that SOC₂ is less than SOC_{MAX_2}, the method 500 proceeds to block 518 and includes obtaining power from the electric grid and charging the second energy storage device until SOC₂ is equal to SOC_{MAX_2}. Based on a determination that SOC₂ is not less than SOC_{MAX_2}, the method 500 proceeds to block 516 and includes obtaining power from the electric grid and powering on one or more energy dissipation devices electrically connected to the second energy storage device.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Unless specified to the contrary within, schematic representations do not correspond one to one with physical structures, and the relative positioning, size, orientation, or other configurations of the components within the schematic representation are not limiting.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for handling an energy expenditure event, the method comprising:
detecting a fault in a first energy storage device;
based on a determination that a state-of-charge of the first energy storage device is above a first threshold value, transmitting energy from the first energy storage device to a second energy storage device that is electrically connected to the first energy storage device; and
based on a determination that the state-of-charge of the first energy storage device has fallen below a second threshold value, which is equal to or lower than the first threshold value, terminating transmission of energy from the first energy storage device to the second energy storage device.

2. The method of claim 1, wherein the first energy storage device is disposed on a first vehicle.

3. The method of claim 2, wherein the second energy storage device is disposed on a stationary device.

4. The method of claim 2, wherein the second energy storage device is disposed on a second vehicle electrically connected to the first vehicle.

5. The method of claim 1, further comprising powering on one or more energy dissipation devices electrically connected to the first energy storage device based on a determination that a state-of-charge of the first energy storage device is above a first threshold value.

6. The method of claim 1, further comprising:
based on a determination that the state-of-charge of the first energy storage device is above the first threshold value and that the first energy storage device is not electrically connected to the second energy storage device, transmitting energy from the first energy storage device to an electric grid that is electrically connected to the first energy storage device.

7. A method for handling an energy expenditure event, the method comprising:
receiving, from an operator of an electric grid, an indication of a negative electric rate for power delivered from the electric grid;
determining a state-of-charge of a first energy storage device;
based on a determination that the state-of-charge of a first energy storage device is less than a maximum state-of-charge, obtaining power from the electric grid and charging the first energy storage device; and
based on a determination that the state-of-charge of the first energy storage device is equal to the maximum state-of-charge, obtaining power from the electric grid and powering on one or more energy dissipation devices electrically connected to the first energy storage device.

8. The method of claim 7, wherein the first energy storage device is disposed on a vehicle.

9. The method of claim 7, wherein the first energy storage device is disposed on a stationary device.

10. The method of claim 9, further comprising;
identifying a second energy storage device that is electrically connected to the first energy storage device;
determining a state-of-charge of the second energy storage device; and
based on a determination that the state-of-charge of the second energy storage device is less than a maximum state-of-charge of the second energy storage device, obtaining power from the electric grid and charging the second energy storage device.

11. The method of claim 10, wherein the second energy storage device is disposed on a vehicle.

12. The method of claim 10, further comprising based on a determination that the state-of-charge of the second energy storage device is equal to the maximum state-of-charge of the second energy storage device, obtaining power from the electric grid and powering on one or more energy dissipation devices electrically connected to the second energy storage device.

13. The method of claim 10, wherein the indication of the negative electric rate for power delivered from the electric grid is generated based upon a surplus of power received by the electric grid from one or more renewable energy sources.

14. The method of claim 10, wherein the indication of the negative electric rate for power delivered from the electric grid includes an indication of the negative electric rate and a duration of the negative electric rate.

15. A system for handling an energy expenditure event, the system comprising:
an electric grid configured to receive power from one or more renewable energy sources;
a stationary device electrically connected to the electric grid, the stationary device including a bi-directional charger, a first energy storage device, and a processing system configured to control an operation of the bi-directional charger;
wherein the processing system is configured to:
receive, from an operator of the electric grid, an indication of a negative electric rate for power delivered from the electric grid;
determine a state-of-charge of the first energy storage device;
based on a determination that the state-of-charge of the first energy storage device is less than a maximum state-of-charge, obtain power from the electric grid and charging the first energy storage device; and
based on a determination that the state-of-charge of the first energy storage device is equal to the maximum state-of-charge, obtain power from the electric grid and powering on one or more energy dissipation devices electrically connected to the first energy storage device.

16. The system of claim 15, further comprising a vehicle electrically connected to the stationary device, the vehicle comprising a second energy storage device and a processing system that is in communication with the processing system of the stationary device.

17. The system of claim 15, wherein the processing system is further configured to obtain power from the electric grid and power on one or more energy dissipation devices electrically connected to the first energy storage device based on a determination that the state-of-charge of the first energy storage device is equal to the maximum state-of-charge.

18. The system of claim 15, wherein the processing system is further configured to:
identify a second energy storage device that is electrically connected to the first energy storage device;
determine a state-of-charge of the second energy storage device; and
based on a determination that the state-of-charge of the second energy storage device is less than a maximum state-of-charge of the second energy storage device, obtain power from the electric grid and charge the second energy storage device.

19. The system of claim 18, wherein the second energy storage device is disposed on a vehicle.

20. The system of claim 19, wherein the processing system of the vehicle is configured to obtain power from the electric grid and power on one or more energy dissipation devices electrically connected to the second energy storage device based on a determination that the state-of-charge of the second energy storage device is equal to the maximum state-of-charge.
